(19) United States
(12) Patent Application Publication
(10) Pub. No.: US 2009/0152938 A1
(43) Pub. Date: Jun. 18, 2009

(54) Connection of spokes and hub of bicycle wheels

(76) Inventor: Rick Tsai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/000,346

(22) Filed: Dec. 12, 2007

(51) Int. Cl. B60B 1/04

(52) U.S. Cl. 301/55; 301/104

(57) ABSTRACT

A bicycle wheel includes a hub including two connection parts on two ends thereof respectively and a plurality of spokes each have a connection ring which is mounted on the connection part. The second ends of the spokes are connected to a rim. The connection parts each have ribs and each connection ring includes recesses defined in an inner periphery thereof, the ribs are engaged with the recesses.

### FIELD OF THE INVENTION

The present invention relates to a bicycle wheel including a hub and spokes, each spoke includes a connection ring to be mounted to the hub.

### BACKGROUND OF THE INVENTION

A conventional bicycle wheel generally includes a hub, a rim and spokes which are connected between the hub and the rim of the wheel. The spokes generally are made by metallic material so as to provide sufficient tension to keep the desired shape of the rim and each of the spokes includes a threaded end which extends through the wall of the rim and a washer and is connected with a nut, the other end of the spoke is hooked to the hub. The assembly process for connecting the spokes between the hub and the rim is a time consuming task because the hooked end of each spoke needs to be hooked with a hole in the hub one by one and the threaded end of each of the spokes has to be aligned with the hole in the rim one by one, and the threaded end of each spoke is threadedly connected to a nut. The long period of time for assembling the spokes to the rim and the hub increases the cost of the wheels and decreases the competitiveness in the market.

The present invention intends to provide a bicycle wheel wherein each spoke includes a connection ring and recesses are defined in an inner periphery of the connection ring, the hub includes two connection parts on two ends thereof and each connection part includes ridges which are engaged with the recesses of the connection ring. The spokes are easily connected to the hub by simply mounting the connection rings to the connection parts.

### SUMMARY OF THE INVENTION

The present invention relates to a bicycle wheel comprising a hub and spokes connected between the hub and the rim. The hub includes two connection parts on two ends thereof respectively and each spoke includes a first end and a second end, the first ends of the spokes are mounted to the connection parts of the hub and the second ends of the spokes are connected to the rim. A connection device is located between the connection parts and the connection rings so as to ensure the connection rings are secured on the connection parts.

The primary object of the present invention is to provide a bicycle wheel which is easily to be assembled.

Another object of the present invention is to provide a bicycle wheel wherein the spokes can be made with multiple spokes connected with the same connection ring so as to further reduce the assembling time.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hub and the spokes of the present invention;

FIG. 2 is an exploded view to show the hub and the spokes of the present invention;

FIG. 3 is an end view to show the wheel of the present invention;

FIG. 4 is an enlarged view to show the connection of the connection ring and the connection part;

FIG. 5 is an exploded view to show a second embodiment of the spokes and the connection rings of the present invention;

FIG. 6 is an enlarged view to show the first connection portion of the connection part of the hub in FIG. 5;

FIG. 7 is an enlarged view to show the second connection portion of the connection ring in FIG. 5;

FIG. 8 is an exploded view to show a third embodiment of the spokes and the connection rings of the present invention;

FIG. 9 shows the positioning device for securing the connection rings of the spokes to the connection parts on the hub;

FIG. 10 shows another embodiment of the positioning device for securing the connection rings of the spokes to the connection parts on the hub;

FIG. 11 is an exploded view to show a fourth embodiment of the spokes and the connection rings of the present invention, and

FIG. 12 is an enlarged view to show the connection of the first connection portion of the connection part and the second connection portion of the connection ring in FIG. 11.

### DETAILED DESCRIPTION OF THE PREFERRED EMBODIMENT

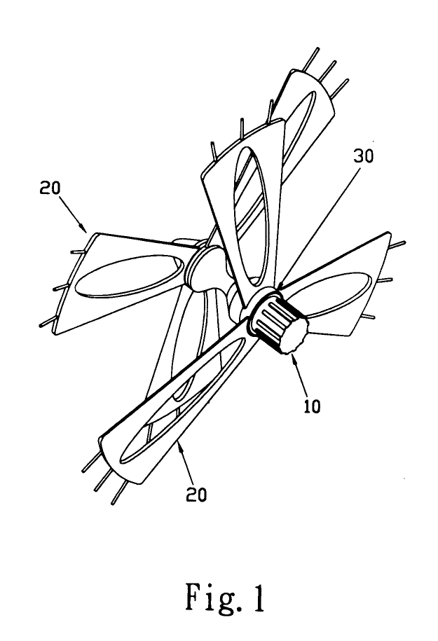

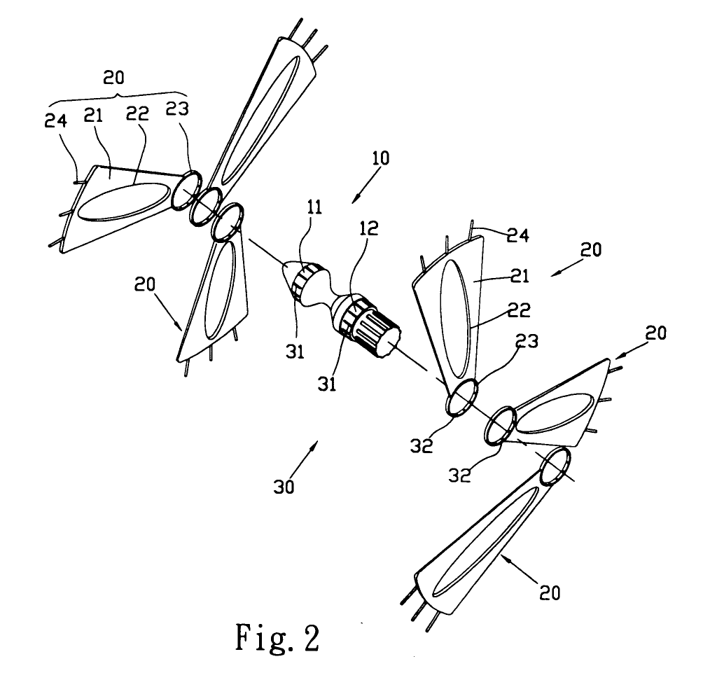

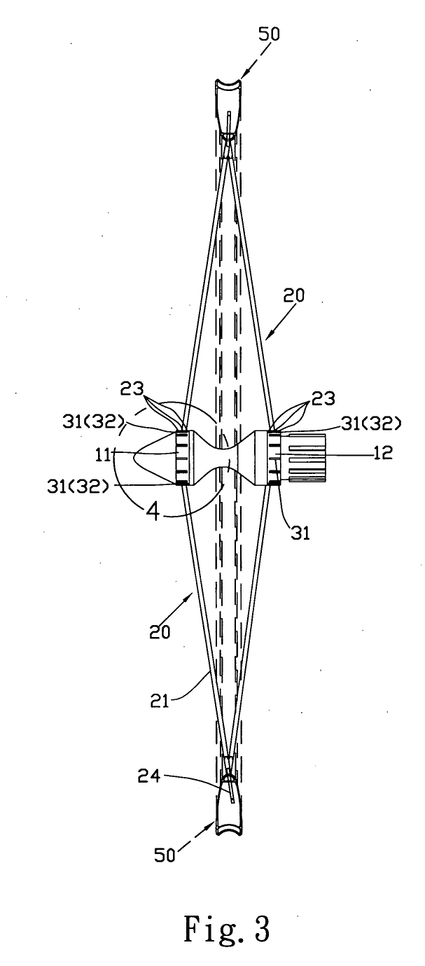

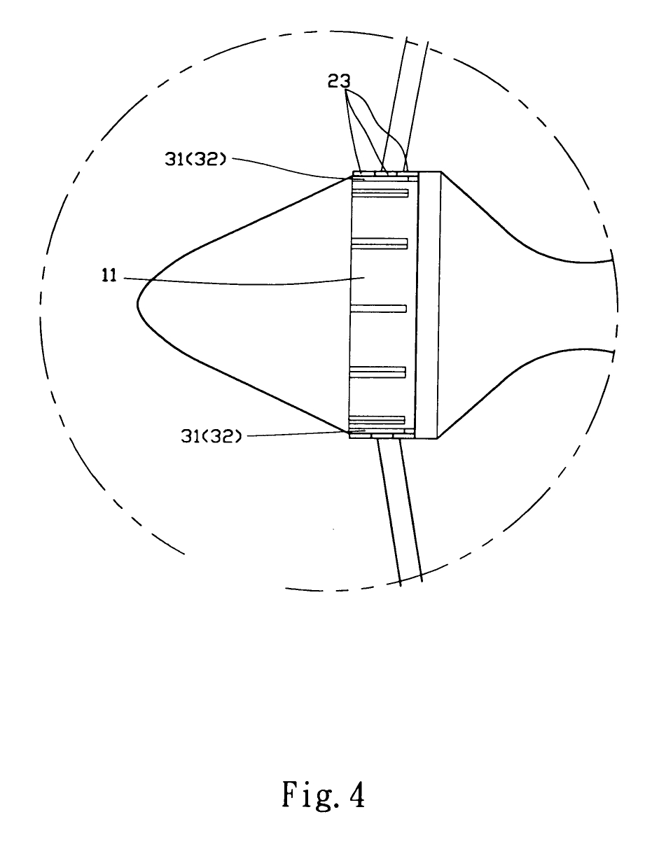

Referring to FIGS. 1 to 4, the bicycle wheel of the present invention comprises a hub 10, a plurality of spokes 20 and a rim 50. The hub 10 includes a narrow central portion and two connection parts 11, 12 are formed on two ends of the hub 10 respectively. Each of the two connection parts 11, 12 includes an annular surface with a proper width. The spokes 20 each are an elongate body 21 and a through hole 22 is defined through the body 21 so as to reduce the material required and its weight. A connection ring 23 is connected to the first end of each spoke 20 and the connection ring 23 is mounted to the connection part 11/21. The second end of each spoke 20 includes three positioning member 24s which are connected to the rim 50. The spoke 20 is connected to the connection ring 23 at an angle relative to a plane on which the connection ring 23 is located.

A connection device 30 is located between the first ends of the spokes 20 and the connection parts 11, 12 of the hub 10 so as to secure the spokes 20 to the connection parts 11, 12. The connection device 30 includes a first connection portion 31 and a second connection portion 32, the first connection portion 31 is located on an outside of each of the connection parts 11, 12 and the second connection portion 32 is located at an inner periphery of each of the connection rings 23. The first connection portion 31 includes ribs extending axially from the outside of each of the connection parts 11, 12, the second connection portion 32 includes recesses defined in the inner periphery of each of the connection rings 23, the ribs are engaged with the recesses.

The spokes 20 are easily and conveniently connected to the hub 10 by mounting the connection rings 23 to the connection parts 11, 12, on the two ends of the hub 10. The ribs are engaged with the recesses to secure the connection rings 23 to the connection parts 11, 12. The width of the connection parts 11, 12 can be made as needed and the number of the connection rings 23 mounted to each of the connection parts 11, 12 are varied according the number of the spokes 20. Each of the spokes 20, the connection ring 23 and the connection device 30 can be integrally made by plastic material or composite material. The number of the ribs and the recesses can also be set according to practical needs.

The first connection portion 31 may include recesses defined axially in the outside of each of the connection parts 11, 12, and the second connection portion 32 includes ribs extending from the inner periphery of each of the connection rings 23. The ribs are engaged with the recesses.

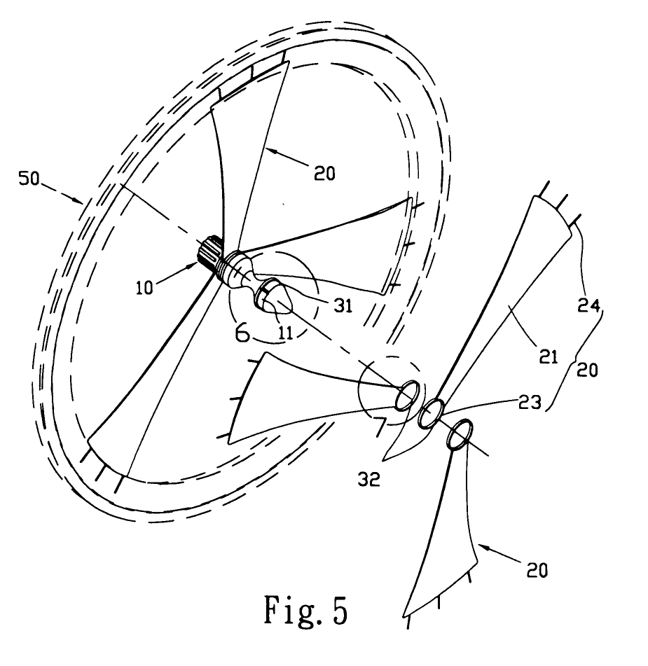

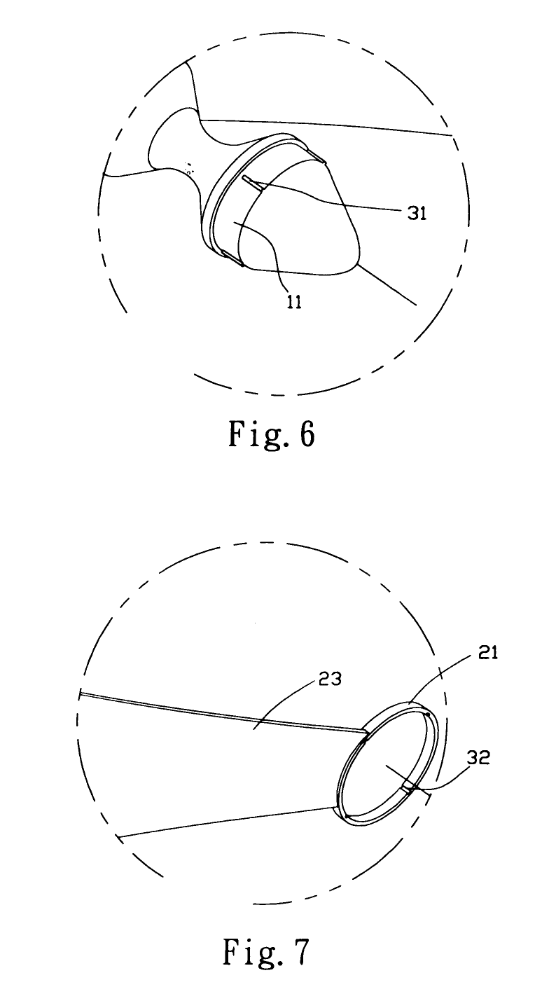

FIGS. 5 to 7 show a second embodiment of the present invention wherein the body 21 of each spoke 20 does not include the through hole 22. There are four ribs for each connection portion 31 and four recesses for each second connection portion 32.

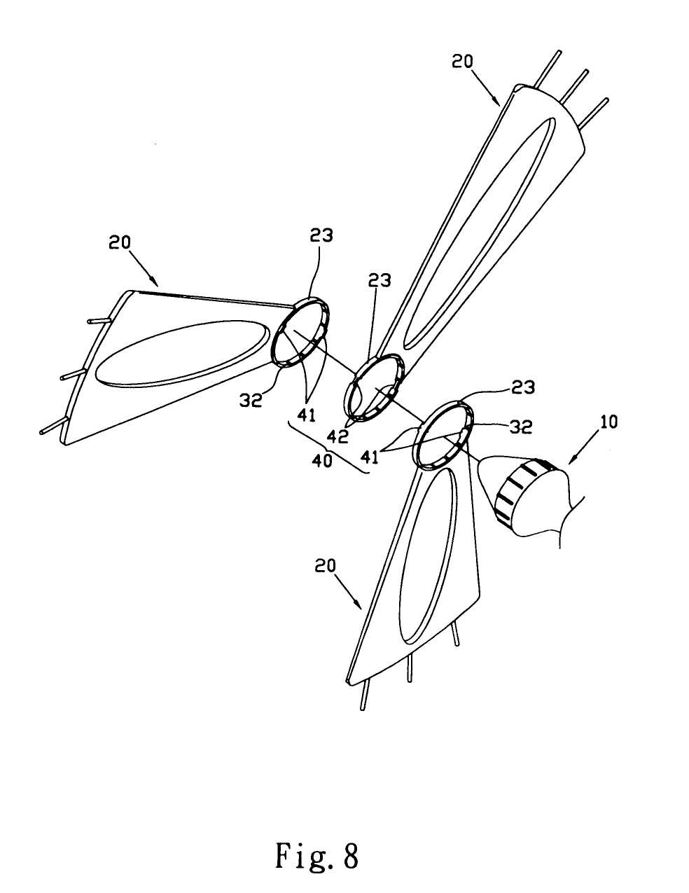

FIGS. 8 to 10 show a third embodiment of the present invention, wherein a positioning device 40 is located between the adjacent connection rings 23 of the spokes 20. The positioning device 40 includes a plurality of protrusions 41 extending axially from one side of the connection rings 23 and a plurality of notches 42 defined axially in two sides of the connection ring 23 which is located between the connection rings 23 with the protrusions 41, the protrusions 41 are engaged with the notches 42.

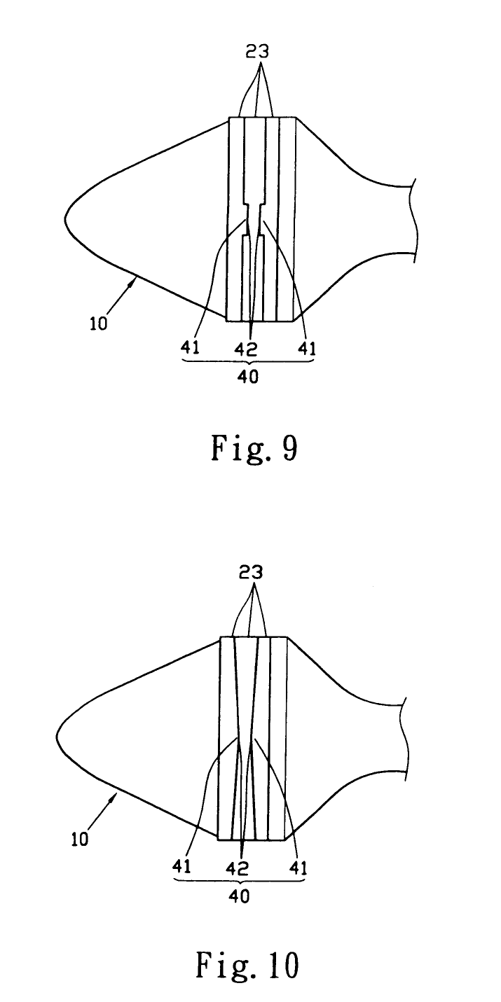

The shape of the protrusions 41 is rectangular and the notches 42 are shaped to receive the protrusions 41 as shown in FIG. 9. The protrusions 41 can also be shaped as a triangle which include two inclined slopes and the notches 42 are shaped to receive the protrusions 41 as shown in FIG. 10.

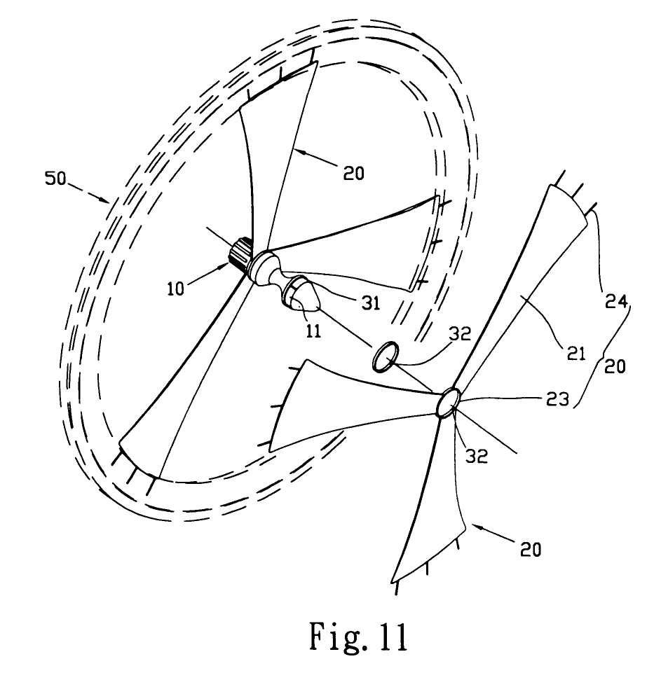

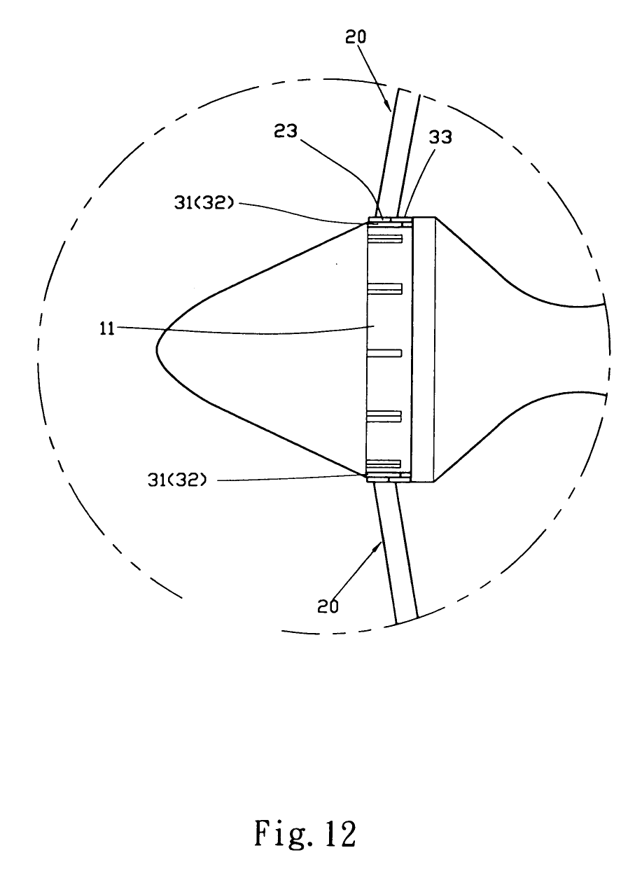

FIGS. 11 and 12 shown a fourth embodiment of the present invention wherein three spokes 20 are connected to the same connection ring 23. By this way, the width of the connection parts 11, 12 can be reduced and the spokes 20 are connected to the hub 10 within one assembling step.

While we have shown and described the embodiment in accordance with the present invention, it should be clear to those skilled in the art that further embodiments may be made without departing from the scope of the present invention.

What is claimed is:

1. A bicycle wheel comprising:
a hub including two connection parts on two ends thereof respectively, and
a plurality of spokes each having a first end and a second end, the first ends of the spokes mounted to the connection parts and the second ends of the spokes connected to a rim.

2. The bicycle wheel as claimed in claim 1, wherein a connection ring is connected to the first end of each spoke and the connection ring is mounted to the connection part.

3. The bicycle wheel as claimed in claim 2, wherein the spoke is connected to the connection ring at an angle relative to a plane on which the connection ring is located.

4. The bicycle wheel as claimed in claim 1, a connection device is located between the first ends of the spokes and the connection parts of the hub so as to secure the spokes to the connection parts.

5. The bicycle wheel as claimed in claim 4, wherein a connection ring is connected to the first end of each spoke and the connection ring is mounted to the connection part, the connection device includes a first connection portion and a second connection portion, the first connection portion is located on an outside of each of the connection parts and the second connection portion is located at an inner periphery of each of the connection rings.

6. The bicycle wheel as claimed in claim 5, wherein the first connection portion includes ribs extending axially from the outside of each of the connection parts, the second connection portion includes recesses defined in the inner periphery of each of the connection rings, the ribs are engaged with the recesses.

7. The bicycle wheel as claimed in claim 5, wherein the first connection portion includes recesses defined axially in the outside of each of the connection parts, the second connection portion includes ribs extending from the inner periphery of each of the connection rings, the ribs are engaged with the recesses.

8. The bicycle wheel as claimed in claim 1, wherein the second end of each spoke includes a positioning member which is connected to the rim.

9. The bicycle wheel as claimed in claim 1, wherein the spokes each include an elongate body and a through hole is defined through the body.

10. The bicycle wheel as claimed in claim 5, wherein each of the spokes, the connection ring and the connection device are integrally made by plastic material.

11. The bicycle wheel as claimed in claim 5, wherein each of the spokes, the connection ring and the connection device are integrally made by composite material.

12. The bicycle wheel as claimed in claim 1, wherein the first end of each of the spokes includes a connection ring which is mounted to the connection part of the hub, a positioning device is located between the adjacent connection rings of the spokes.

13. The bicycle wheel as claimed in claim 12, wherein the positioning device includes at least one protrusion extending axially from one of the connection ring and at least one notch defined axially in the adjacent connection ring, the at least one protrusion is engaged with the at least one notch.

14. The bicycle wheel as claimed in claim 1, wherein the first ends of the spokes are connected to one connection ring which is mounted to the connection part.
